(19) United States
(12) Patent Application Publication
(10) Pub. No.: US 2002/0015560 A1
(43) Pub. Date: Feb. 7, 2002

(54) Coupling system between an optical fibre and an optical device

(76) Inventors: Marco De Donno, Maglie (IT); Francesco Schiattone, Novedrate (IT)

Correspondence Address: Finnegan, Henderson, Farabow,, Garrett & Dunner, L.L.P., 1300 I Street, N.W., Washington, DC, 20005-3315, US

(21) Appl. No.: 09/885,966

(22) Filed: Jun. 22, 2001

Related U.S. Application Data
(63) Continuation of application No. PCT/EP99/09645, filed on Dec. 6, 1999.
(60) Provisional application No. 60/115,591, filed on Jan. 12, 1999.

(30) Foreign Application Priority Data
Dec. 24, 1998 (EP) 98124650.7

(51) Int. Cl. G02B 6/26; G02B 6/32

(52) U.S. Cl. 385/38; 385/33

(57) ABSTRACT

Coupling system between an optical waveguide (1) and an optical device (8) suitable for receiving and/or transmitting an optical beam having a first maximum MFR, comprising a single-mode optical fiber (1) having at one end a portion (10) of its core (2) expanded with a second MFR. An aspherical lens (6) is formed on said end of the fiber (1). Said aspherical lens comprises a pair of inclined surfaces (41, 42) which intersect on a line, generating an edge, in a position substantially corresponding to the center of said core (2), said edge is rounded to form an aspherical profile.

This invention relates to an optical fibre termination particularly suitable for receiving optical beams from optical devices with which the optical fibre is coupled. The fibre termination is additionally suitable for the efficient emission of an optical beam which is transmitted to said optical devices.

Generally speaking, for the purposes of this invention, by optical device is meant any optical device requiring an efficient coupling with an optical fibre in which the optical beam to be coupled is emitted by the device towards the fibre or is sent from the fibre into the device, or envisages both of these cases.

In all applications in the field of optical telecommunications, the coupling between an optical device and a fibre is one of the fundamental aspects since the amount of power that is transferred along the fibre and the proper transfer of the information contained in the optical beam are both determined by this coupling. One example of this type, where the optical beam is transferred from the device to the fibre, is represented by the coupling between a laser and a fibre. In this case, the laser is the device that generates the optical beam, upon which the information is overlaid, and which is sent through an optical fibre along a line. Similarly, all the active and passive devices capable of guiding a single-mode radiation are also considered optical devices.

A different type of coupling, in which the optical beam is transferred from the fibre to the device, is that represented by the termination of a fibre associated with a device receiving the optical beam coming out of the fibre.

A further example is represented by the coupling between a fibre termination and a semiconductor optical amplifier. In this case, the coupling is critical both in the step of emitting the amplified signal which is put into the fibre at the amplifier outlet and in the step of receiving the signal which must be input to the amplifier in order to be suitably amplified.

The coupling between an optical device and an optical fibre represents one of the critical points for an optical system, for instance for an optical telecommunications system, in that the optical power transferred may undergo attenuation. This is because the optical beam emitted by an optical device is generally elliptical and/or divergent and must be transformed into a circular beam of suitable dimensions in order to be put into the fibre efficiently. This inevitably causes losses because the micro-optical components used are not capable of completely annulling the losses. Another critical factor is the alignment between the fibre and the device; if this is not perfect, a portion of the optical beam coming out of the device may not be collimated.

If we take P_{O} to indicate the optical power emitted by the device and P_{F} the power successfully delivered to the fibre, then the ratio between the said two quantities defines the efficiency of the coupling. More specifically:

$${η}_{0} = \frac{{P}_{F}}{{P}_{0}} \qquad ( 1 )$$

where ηₒ is the coupling efficiency to be maximized in order to transmit the maximum power from the device to the fibre and/or vice versa.

This coupling efficiency ηₒ may be expressed as a function of the fundamental mode Eₒ of the fibre and of the single mode Eᵢ of the optical device in the following way:

$${η}_{0} = \frac{{\vert {\int }_{z = 0} {E}_{i} \cdot {E}_{0}^{*} ⅆ A \vert}^{2}}{{\int }_{z = 0} {\vert {E}_{0} \vert}^{2} ⅆ A \cdot {\int }_{z = 0} {\vert {E}_{i} \vert}^{2} ⅆ A} \qquad ( 2 )$$

The integrand of the numerator is the scalar product of the local electric field of the incident wave Ei and the excited mode Eₒ in the fibre on the fibre termination plane where the integral is calculated. The expression (2) is commonly known as the overlap integral, since the scalar product is nullified as soon as at least one of the two variables assumes a zero value.

One solution frequently used to increase ηₒ is that of fabricating a microlens on the end of the fibre that is associated with the device.

Some of the types of lenses to be disposed on the termination of optical fibres are described in the known art.

U.S. Pat. No. 4,490,020 describes a coupling system between an optical fibre and a semiconductor laser wherein the terminal part of the fibre is made as a pyramid-shaped lens having a semielliptical apex, in such a way that the width of said terminal part decreases in diameter towards the apex on two planes, parallel and perpendicular respectively to the plane of junction between fibre and laser, thereby providing different radii of curvature. Accordingly the light transmitted by the semiconductor laser is coupled with the fibre termination on both planes, i.e. parallel and perpendicular to the plane of junction between fibre and laser.

In U.S. Pat. No. 5,455,879 (Moldavis et al.), a lens disposed on the termination of an optical fibre is described, together with a corresponding method for making a lens on the termination of an optical fibre. In particular, the lens comprises a first pair of surfaces which intersect each other along a line which is in a position corresponding to half of the core of the fibre. The lens also comprises a second pair of surfaces which intersects the first pair of surfaces and in which the slope of said second pair of surfaces is less than the slope of the first pair of surfaces. These slopes are measured with respect to a plane perpendicular to the longitudinal axis of the fibre. In this case, therefore, the lens has a double-slope wedge configuration, the slope being more accentuated close to the centre of the fibre and less so on the outside.

In patent IT1289261, a machining procedure is described with which a microprism can be produced directly on the tip of an single-mode optical fibre by means of lapping. The microprism can have a pre-established angle of aperture and is optically centred with respect to the core of the fibre with great accuracy. The procedure of the invention means that the effects of the tolerances for centring the core with respect to the geometrical axis of the optical fibre can be eliminated and the periodical inspections of the tip of the fibre during machining dispensed with.

In the article “Lens on wedge for high efficiency coupling between fiber and pump laser” by V. Annovazzi-Lodi et al., published on Jun. 25, 1998 for the Networks and Optical Communication '98 Conference (NOC '98), a procedure is illustrated for producing a wedge on the termination of a single-mode fibre in order to improve the coupling between the fibre and a laser source. The wedge-shaped fibre tip may have an aspherical lens, which reduces the problems involved in centring the beam coming from the laser source with the single-mode fibre.

The Applicant has observed that in all these solutions which envisage producing the lens on the tip of the fibre, a constraint is imposed on design of the best profile for the microlens by the diameter of the fibre core. This value is in fact an intrinsic parameter of the fibre and accordingly is considered to be fixed. This in turn is due to the fact that the dimensions of the fibre core are imposed by the type of fibre connected to the source. This is because the section of fibre coupled with the source must be further connected to a coupler or other component, an optical fibre for example. Additionally, to achieve the best transfer of power, the two fibres must be of the same type, particularly regarding the dimension of their cores.

In particular, the couplers used to combine the pumping radiation and an optical signal at an optical fibre amplifier advantageously have an MFR selected to permit the single-mode propagation of the pumping radiation as well as of the signal radiation. For example, for the pumping of amplifiers made of fibre doped with erbium, a pumping radiation with λₚ=980 nm is commonly used. The single-mode fibres with this wavelength preferably have an MFR of less than about 3 μm, for example of about 1.8 μm.

Rather than refering to the dimensions of the core, the value that we will refer to in describing a fibre is the mode field diameter (MFD) or mode field radius (MFR), which is a function of the core diameter (or radius), of the refractive index step and of the radiation wavelength. More specifically, the MFR is the distance radially from the centre of the fibre core to the point at which the power profile of the optical beam travelling through the said fibre is reduced to a fraction 1/e².

For a step-index fibre, i.e. a fibre in which n₁, is the constant refractive index of the core and n₂ is the constant refractive index of the cladding and n₁>n₂, a formula widely used to give the MFR ω_{ƒ}is as follows:

ω_{ƒ}=(0.65+1.619/V^{3/2}+2.879/V⁶)·r

where r is the core radius and V is the normalized frequency given by:

V=(2πr/λ)·(n²₁−n²₂)^{½}

It should be remembered that the formula expressing ω_{ƒ}is to be held valid for 1.9<V<2.405, this being the range corresponding to refractive index step values typical of a single-mode optical fibre.

Similarly, to describe the beam emitted by or propagating in an optical device, the MFR represents the radial distance from the centre of the emitted beam to the point at which the power profile of said optical beam is reduced to a fraction 1/e². This value is measured on the plane of emission or input of the beam of the device. In the case of an optical beam with an asymmetrical cross section, propagating in an optical device, for example an elliptical beam, it is possible to define a maximum and a minimum MFR for the beam.

The Applicant has noted that it is possible to modify the MFR on the termination of an optical fibre. Among the various techniques that may be used for this purpose, the one that envisages local heating of a portion of the fibre and cutting of the fibre local to the heated part was found to be particularly advantageous. In this way, a fibre is obtained on the cut end with the starting external geometrical dimensions but with an expanded core. The fibres obtained using this core expansion technique, and which are known per se, are called TEC (Thermal Expanded Core). The core can be expanded to produce a predetermined MFR.

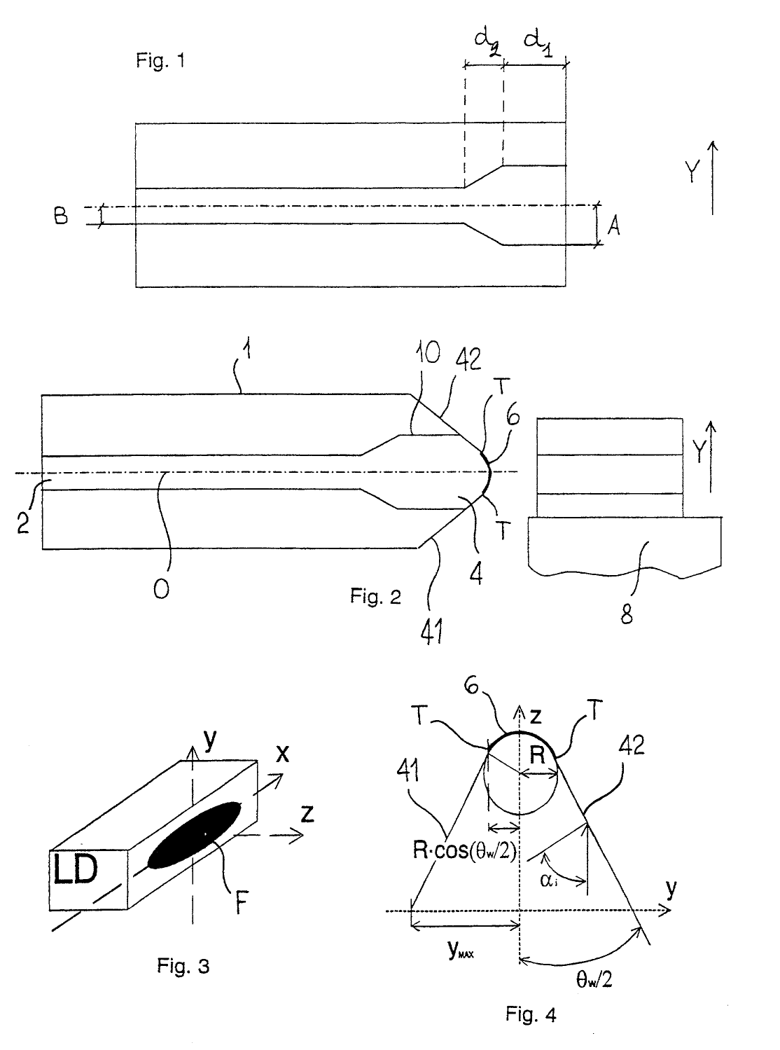

To better understand how TEC fibres are produced, it should be borne in mind that, in step-index optical fibres, the refractive index of the core is greater than that of the cladding and this difference is given by the presence in the core of a certain amount of doping agent (usually germanium). Local heating of the fibre results in migration of the doping agent from the core to the cladding and this produces the expansion of the core (FIG. 1).

TEC fibres and a method for producing them are described in the article “Fabrication of an expanded core fiber having MFD of 40 μm preserving outer diameter” published in the magazine Photonics Technology Letters, vol. 6, no. 7 of July 1994, pages 842-844.

TEC fibres are generally used in optical connectors. These connectors are components used for making removable optical connections. In this field of application, the TEC fibres are simply cut and the MFR is expanded with a view to reducing the losses due to transversal misalignments. The literature also cites solutions which envisage the use of TEC fibres for the coupling with laser sources. In such configurations, a discrete lens is interposed between fibre and source.

For example, in the article published in the magazine Photonics Technology Letters, vol. 3, no. 5 of May 1991, pages 469-470, a fibre termination in which a core expansion was generated, i.e. a TEC fibre, is described, coupled with a laser source. A discrete aspherical lens is set between the laser and the TEC fibre, allowing the tolerance to misalignments to be extended. The article states that the minimum coupling losses (and thus the maximum coupling efficiency) are almost the same for fibres having different core expansion values (MFD) and that the optimal distance between the TEC fibre and the lens increases as the MFD is increased.

The article published in the magazine Electronics Letters of Mar. 17, 1988, vol. 24, no. 6, pages 323-324 describes a method for coupling a single-mode fibre with a laser diode through a spherical ruby lens. The fibre core is suitably expanded to offset the effects of misalignment between the fibre and the laser, while maintaining a high coupling efficiency for the optical power transmitted by the laser to the fibre.

The Applicant has observed that these solutions have the drawback of not being of simple and compact fabrication. There are, in fact, three elements to be aligned in these cases: fibre, lens and laser, the lens being an entity separate from both the fibre and the laser. The lens therefore requires means for maintaining the alignment between the lens itself and the fibre. More specifically, each of the three parts needs such means for mounting and aligning.

The Applicant has addressed the problem of improving the coupling efficiency between an optical fibre and a light source, the emitted beam of which is highly elliptical and has a lateral dimension greater than the fibre core diameter.

The Applicant has observed that it is possible to improve the coupling efficiency between a fibre and an optical device having different MFRs, beyond the values permissible in the known art by locally modifying the MFR of the fibre, in the terminal area of the fibre that is to be coupled with the device. It has also been noted by the Applicant that the coupling efficiency can be improved considerably by selecting an MFR value for the fibre termination as a function of the mode field radius of the radiation at the outlet of the optical device.

It was found in particular that, by using a fibre with an expanded core in the terminal part and by making a cylindrical lens on this termination, placed on the advantageously elongated wedgelike apex, a dimensional harmony is obtained between the fibre diameter and that of the beam emitted from the fibre and the ellipticity of the optical beam emitted by the source is compensated, thereby obtaining improved coupling efficiency and hence better transfer of the optical power.

According to a first aspect thereof, this invention relates to a laser emission system comprising

a laser suitable for transmitting an elliptical optical beam at an emission wavelength of less than 1000 nm, having a first maximum MFR, comprising a flared optical waveguide,

a single-mode optical fibre at said emission wavelength, having a terminal portion with a second MFR,

characterized in that said MFR of said fibre does not differ from said first maximum MFR of the laser by more than 20%,

an aspherical lens is formed on said terminal portion of said optical fibre.

Preferably said aspherical lens is a cylindrical lens.

More specifically, said aspherical lens comprises a pair of inclined surfaces which intersect on a line, generating an edge, in a position substantially corresponding to the centre of the core of said fibre, said edge being rounded to form an aspherical profile.

In particular, said fibre is of the TEC (Thermal Expanded Core) type.

Preferably said inclined surfaces together form an angle that is greater than the critical angle.

More specifically, said inclined surfaces together form an angle that is greater than the critical angle by not more than 10°.

Preferably said inclined surfaces together form an angle that is greater than the critical angle by not more than 3°.

According to a further aspect thereof, the invention relates to a coupling system between an optical waveguide and an optical device suitable for receiving and/or transmitting an optical beam having a first maximum MFR, comprising a single-mode optical fibre having at one end a portion of its core expanded by at least 10% so as to determine a second MFR,

characterized in that

an aspherical lens is formed on said end of the fibre.

Preferably said aspherical lens is a cylindrical lens.

More specifically, said aspherical lens comprises a pair of inclined surfaces which intersect on a line, generating an edge, in a position substantially corresponding to the centre of said core, said edge being rounded to form an aspherical profile.

In particular, the value of said MFR of said fibre along the direction of the greater axis of the elliptical beam does not differ from the MFR value of the optical device by more than 20%.

Preferably the value of said MFR of said fibre in the direction of the greater axis of the elliptical beam does not differ from the MFR value of the optical device by more than 10%.

Preferably said fibre is of the TEC (Thermal Expanded Core) type.

More specifically, the inclined surfaces together form an angle that is greater than the critical angle.

Preferably the inclined surfaces together form an angle that is greater than the critical angle by not more than 10°.

Preferably the inclined surfaces together form an angle that is greater than the critical angle by not more than 3°.

According to another aspect thereof, the invention relates to a coupling system between an optical fibre and an optical device suitable for transmitting and/or receiving an optical beam

characterized in that,

one termination of said optical fibre comprises an aspherical lens disposed on the edge of a wedge formed by a pair of inclined surfaces, said surfaces together forming an angle that is greater than the critical angle by not more than 10°.

According to yet another aspect thereof, the invention relates to a method for coupling a single-mode optical fibre with an optical device receiving or transmitting an elliptical optical beam characterized in that it comprises the following steps:

expanding the geometrical dimensions of the core of said fibre so as to obtain an MFR that does not differ from the MFR value of the optical device by more than 20% along the direction defined by the greater axis of the elliptical beam,

making a wedge on the termination of the fibre, the edge of which corresponds to this greater axis, said wedge having an angle greater than the critical angle,

making an aspherical lens on the edge of this wedge.

In particular, said wedge has an angle that is greater than the critical angle by not more than 10°.

Preferably said wedge has an angle that is greater than the critical angle by not more than 3°.

According to a further aspect thereof, the invention relates to an optical fibre suitable for coupling with an optical device, comprising a single-mode optical fibre having a core with a first MFR and a portion of its core expanded with a second MFR greater than said first MFR by at least 10%,

characterized in that

an aspherical lens is formed on said end of the fibre.

Preferably said aspherical lens is a cylindrical lens.

More specifically, said aspherical lens comprises a pair of inclined surfaces which intersect on a line, generating an edge, in a position substantially corresponding to the centre of said core, said edge being rounded to form an aspherical profile.

Preferably said fibre is of the TEC (Thermal Expanded Core) type.

In particular, the inclined surfaces together form an angle that is greater than the critical angle.

Preferably the inclined surfaces together form an angle that is greater than the critical angle by not more than 10°.

Preferably the inclined surfaces together form an angle that is greater than the critical angle by not more than 3°.

According to yet another aspect thereof, the invention relates to an optical fibre suitable for coupling with an optical device, comprising on one of its terminations an aspherical lens disposed on the edge of a wedge formed by a pair of inclined surfaces, characterized in that

said inclined surfaces together form an angle that is greater than the critical angle by not more than 10°.

Further details may be obtained from the following description, with reference to the accompanying drawings in which:

FIG. 1 shows a TEC fibre in longitudinal cross section;

FIG. 2 shows an optical fibre termination in longitudinal cross section, according to a preferred embodiment of this invention;

FIG. 3 is a three-dimensional graph of an indicative optical beam exiting from an optical device;

FIG. 4 is a two-dimensional graph, according to a plane Y-Z, of the profile of the fibre termination according to this invention;

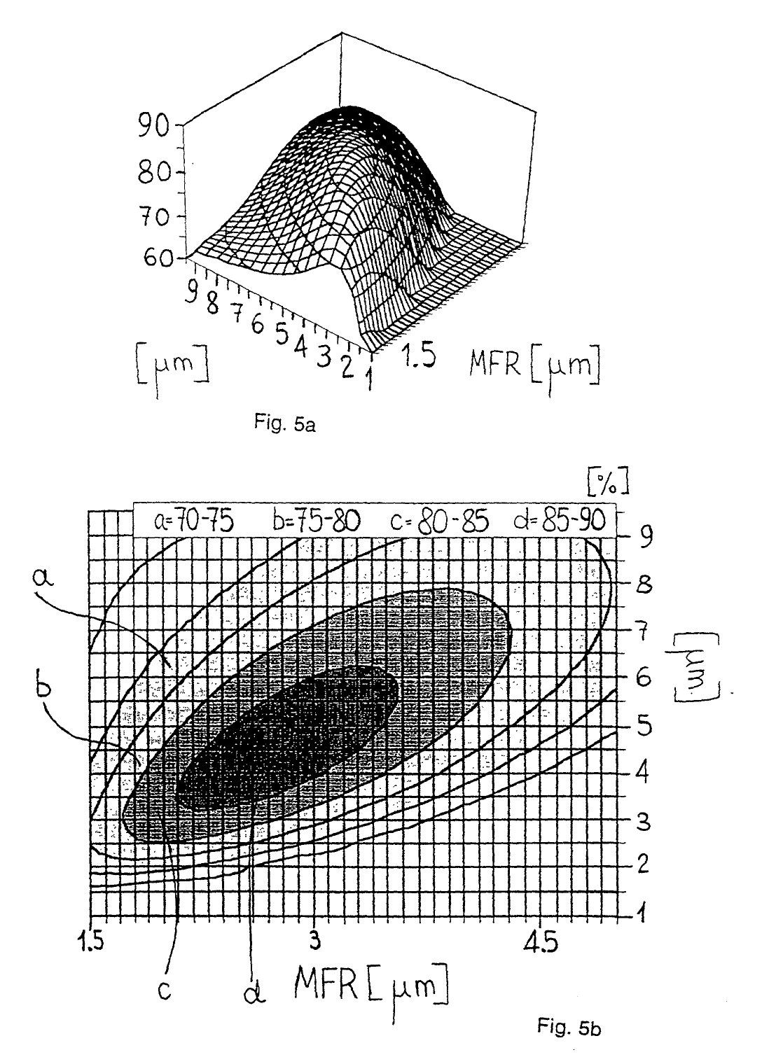

FIG. 5a is a three-dimensional graph representing the relationship between the radius of the lens, the MFR of the fibre and the coupling efficiency, considering a wedge on the termination of the lens having an angle θ of 55°;

FIG. 5b is the same graph as in FIG. 5a shown two-dimensionally;

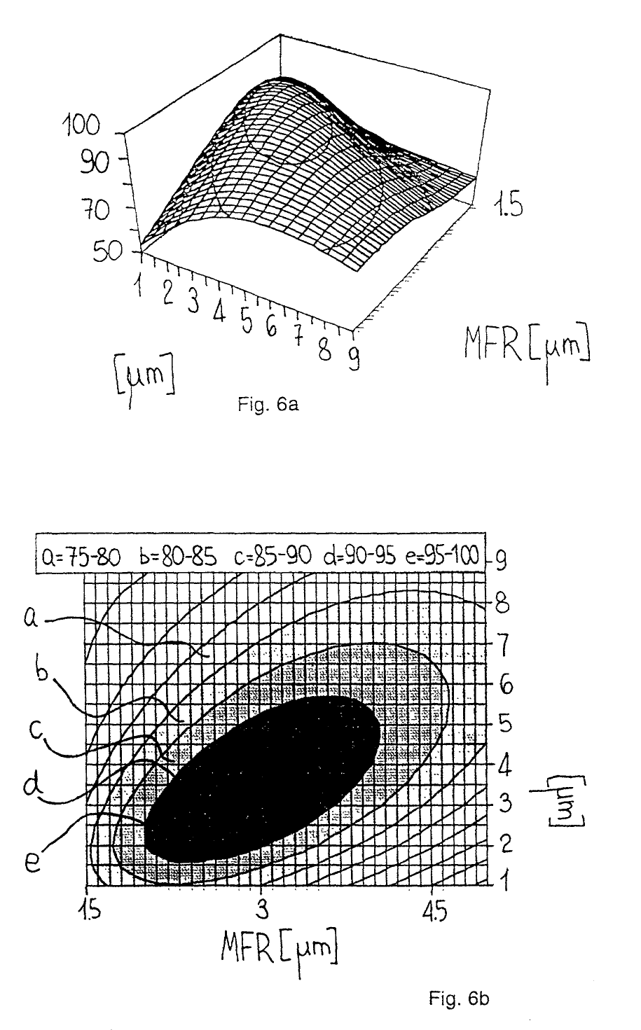

FIG. 6a is a three-dimensional graph representing the relationship between the radius of the lens, the MFR of the fibre and the coupling efficiency, considering a wedge on the termination of the lens having an angle θ of 110°;

FIG. 6b is the same graph as in FIG. 6a shown two-dimensionally;

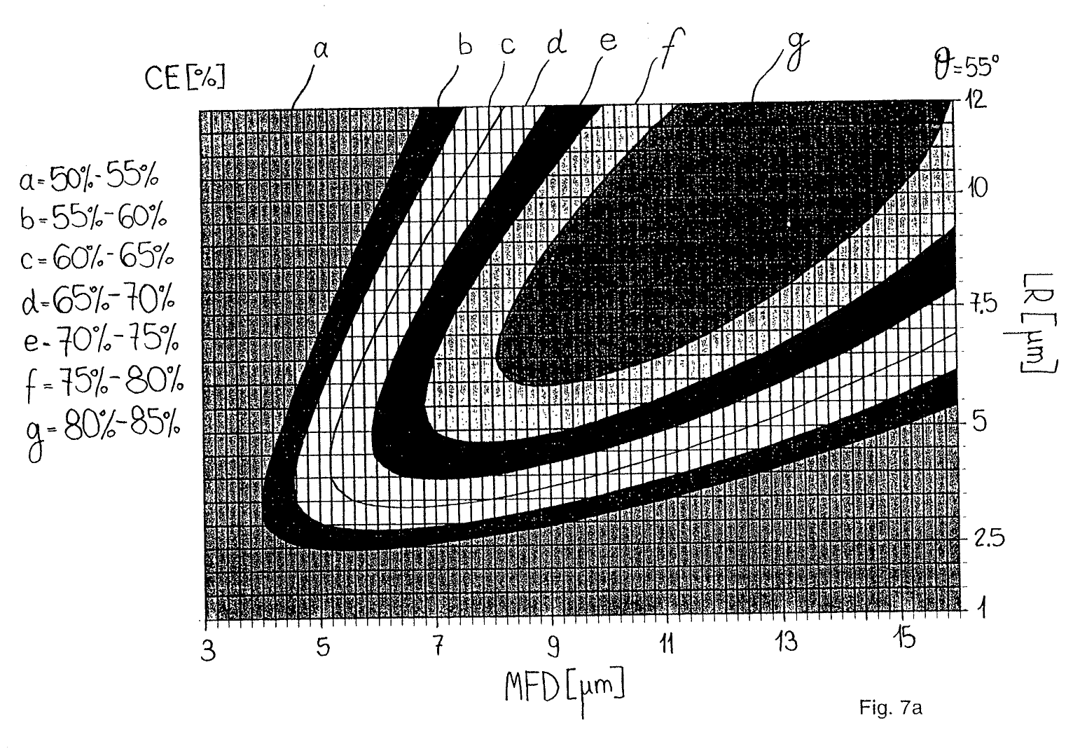

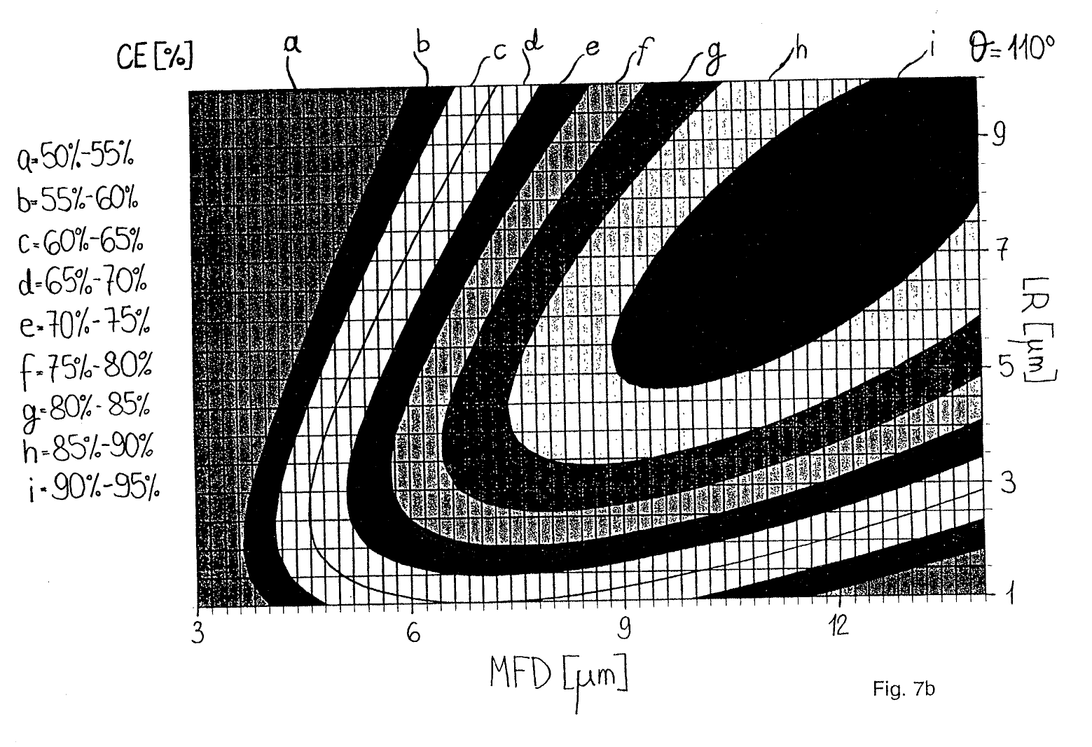

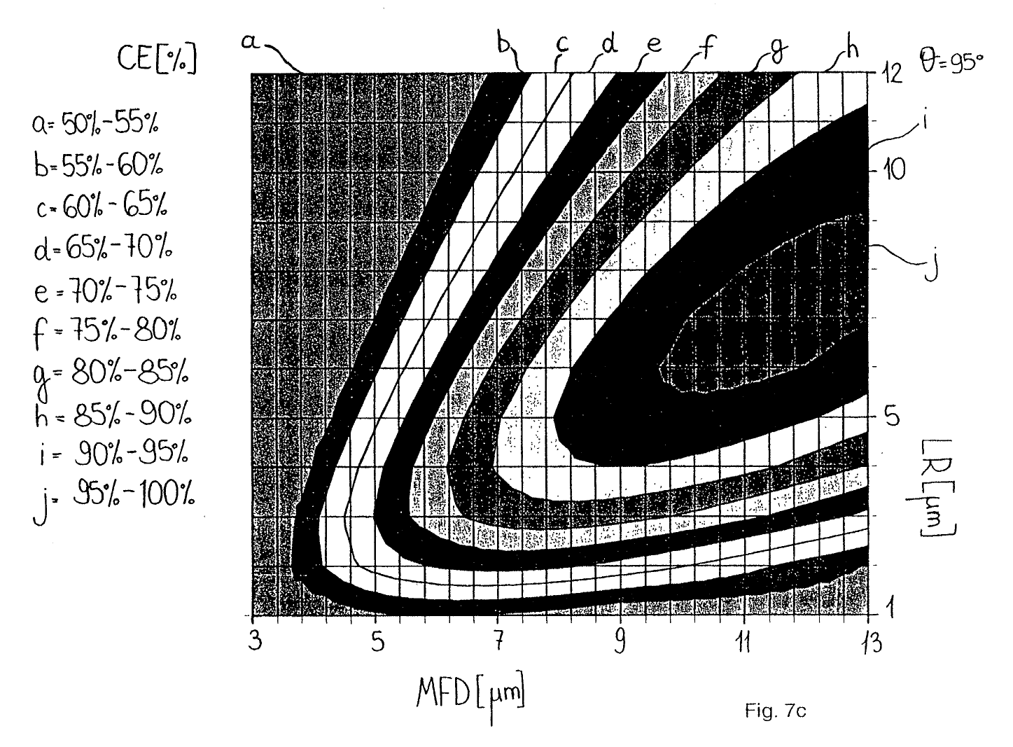

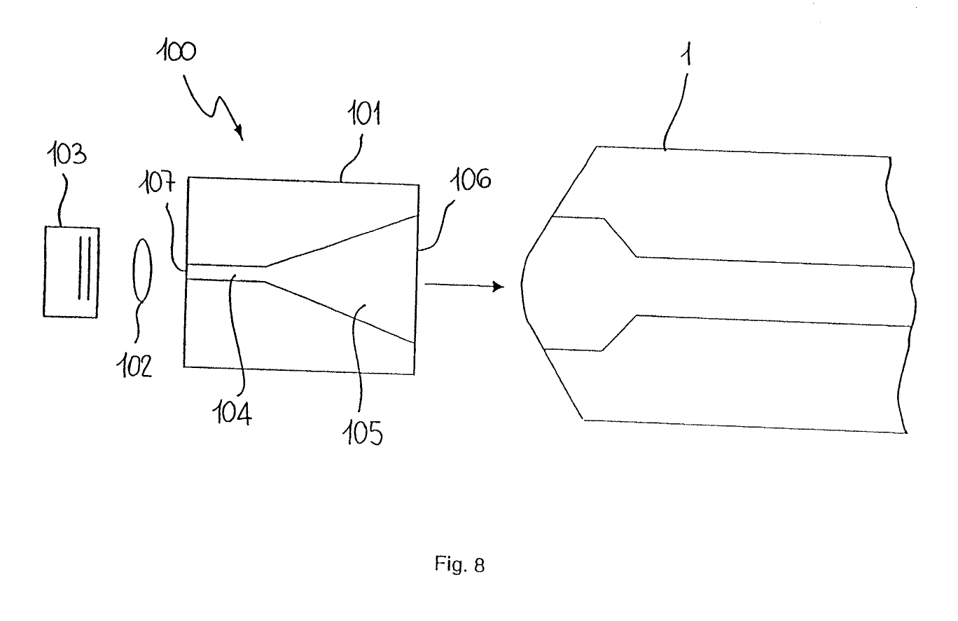

FIG. 7a is a graph representing the relationship between the radius of the lens, the MFR of the fibre and the coupling efficiency, considering a wedge on the termination of the lens having an angle θ of 55° using a flared laser;

FIG. 7b is a graph representing the relationship between the radius of the lens, the MFR of the fibre and the coupling efficiency, considering a wedge on the termination of the lens having an angle θ of 110° using a flared laser;

FIG. 7c is a graph representing the relationship between the radius of the lens, the MFR of the fibre and the coupling efficiency, considering a wedge on the termination of the lens having an angle θ of 95° using a flared laser;

FIG. 8 represents a coupling between a single-mode fibre and a flared laser according to this invention.

FIG. 1 depicts a termination of a TEC type optical fibre, in which expansion of the core is illustrated. The following parameters in particular can be seen: A represents the maximum radius of fibre core expansion, B the radius of the fibre core in the non-expanded portion, d1 the length of the expanded core and d2 the portion of length over which expansion takes place. Typical values are a few mm for d1 and d2 to grant a sufficient tolerance in the subsequent machining process. For instance, d1 can be approximately 3 mm.

TEC fibres with different predetermined MFR values, up to approximately 5 times the MFR of the original fibre, are commercially available, from NTT and Sumitomo (JP) for example.

In general, according to this invention, the expansion of the terminal part of the core of the fibre (A-B)/B is of at least 10%, preferably at least 20%. As a result, the MFR of the terminal part of the fibre is at least 10% and preferably at least 20% greater than the MFR of the fibre in the non-expanded portion.

FIG. 2 illustrates the termination of a single-mode optical fibre 1 according to one aspect of this invention, comprising an expanded portion 10 of the fibre core 2 and a wedge-shaped portion 4 of the fibre termination. This wedge-shaped portion comprises two surfaces 41 and 42 which intersect on a line, generating an edge, in a position substantially corresponding to a line passing through the centre of the core 2. A lens 6 is formed on the tip of the fibre, joining this edge over the entire length of said line. Preferably the termination of the fibre is coated with a layer of non-reflecting material, obtained according to a known technique. Also depicted in the figure is an optical device, represented indicatively by a source 8 of emission of a divergent light beam, such as a semiconductor laser.

On the basis of the parameters cited previously, which refer to the fibre termination, we shall now describe how to calculate the ideal profile for the lens to be formed on the tip of the fibre.

When using a microlens made on the end of the optical fibre, it is still possible to refer to the overlap integral model cited earlier.

Particularly depicted in FIG. 3 is the waveform of an optical beam F, referred to a system of Cartesian axes x, y and z, exiting from an optical device, such as an LD semiconductor laser having a junction on the plane perpendicular to the y axis. In the Gaussian beams theory, optical elements are schematized simply as phase transformers. The expression of the laser field E′ on the plane z=0, which represents the plane that passes through the fibre termination not elongated into a wedge, is given by:

E′(x,y,z=0)=E(x,y,z=0) exp [−i (2π/λ) (n_{fibre}−1) Δ(x,y)] T(x,y) (3)

where Δ(x,y) is the thickness of the microlens as a function of the transverse coordinates whereas T(x,y) takes into account the finite aperture of the lens and is defined as:

$$T ( x , y ) = \{ \begin{matrix}1 & 0 < \sqrt{{x}^{2} + {y}^{2}} \leq {R}_{c} \\ 0 & \sqrt{{x}^{2} + {y}^{2}} > {R}_{c}\end{matrix} \qquad ( 4 )$$

where R_{c} represents the finite aperture of the lens, i.e. the maximum width of the ideal window inside which the optical beam is received in the fibre and n_{fibre} is the refractive index of the fibre core.

The value of R_{c} can be calculated easily by inverting the direction of propagation of the optical beam (from the fibre to the optical device): the incident wave will thus be a plane wave, the description will be simplified while at the same time the value of the overlap integral remains unchanged on account of the reciprocity property.

With reference to FIG. 4, and considering the general case of a cylindrical microlens of radius R, if Snell's law is applied, an expression can be obtained for the critical angle α_{c}, which represents the maximum permissible angle of the incident beam with respect to the longitudinal axis O of the fibre:

α_{c}=arcsin(nₐᵢᵣ/n_{fibre}) (5)

while the following also applies:

R_{c}=R sin α_{c} (6)

since the maximum slope of the profile of the lens for which the optical beam is received corresponds to the critical angle α_{c}.

Therefore, from (5) and (6), we obtain:

R_{c=}R (nₐᵢᵣ/n_{fibre}) (7)

Let us now examine the case of the fibre heading of single-mode optical devices that emit an elliptical beam which, for example, is much more divergent in the direction perpendicular to the junction (y direction in FIG. 3) than in the direction parallel thereto (x direction in FIG. 3). If the divergence along the x direction is low, then when we remain very close to the outlet face of the beam, the wavefronts of the latter can be assumed to be plane in the x direction and curved in they direction; in other words, the beam may be considered collimated in one direction and divergent in the other. It can be seen that divergence of the beam is greater in the direction (y in FIG. 3) corresponding to the minimum MFR.

Therefore, with an elliptical beam, or more generally in a situation in which the beam emitted by the device is divergent, in order to reduce the phase decoupling, a microlens having the profile of a cylinder or of a portion of a wedge terminating in a cylindrical lens can be used to good effect. An advantageous solution is that envisaging the use of a cylindrical lens set on a wedge made on the end of the fibre. The edge of the wedge is parallel to the x direction, i.e. to the direction corresponding to the greater axis of the elliptical beam being output by the device. As may be seen in FIG. 4, the wedge profile intersects that of the cylinder at the point of tangency T. Therefore the thickness of the lens as a function of the transverse coordinates is given by:

$$Δ ( y ) = \{ \begin{matrix}\frac{{y}_{MAX} - R \cdot cos ( {θ}_{w} / 2 )}{tan ( {θ}_{w} / 2 )} + \sqrt{{R}^{2} - {y}^{2}} - R \cdot sin ( {θ}_{n} / 2 ) & \vert y \vert \leq R \cdot cos ( {θ}_{w} / 2 ) \\ \frac{{y}_{MAX} - \vert y \vert}{tan ( {θ}_{w} / 2 )} & R \cdot cos ( {θ}_{w} / 2 ) < \vert y \vert \leq {y}_{MAX}\end{matrix} \qquad ( 8 )$$

where θ_{w} is the angle of the wedge that the lens is placed on, R is the radius of the cylindrical microlens and y_{MAX} is half of the transverse dimension of the lens.

It is important to evaluate to what extent the finite aperture of the microlens R_{c} affects the coupling efficiency. To this end, and again assuming that the direction of propagation of the optical beam is from the fibre to the outside, take the simple case of a lens having a wedge-shaped profile. In a situation such as this, as may be seen in FIG. 4, the maximum angle of incidence αᵢ of the optical beam (angle of acceptance) is equal to the complementary angle of half of the wedge angle, namely:

αᵢ=90°−θ_{w}/2 (9)

For the purposes not only of the coupling efficiency, but also of the sensitivity to misalignments along they direction, it may prove extremely useful for the wedge angle θ_{w} not to restrict the aperture of the system fibre+wedge+lens.

This is obtained when:

θ_{w}>θ_{w.critical} (10)

where

θ_{w.critical}=2·(90°−α_{c}) (11)

which is obtained by replacing αᵢ with α_{c} in (9).

Let us now focus our attention on the angle θ_{w} of the wedge that the cylindrical lens is fabricated on.

The fact that the wedge profile intersects that of the cylinder at the point of tangency T guarantees that there will not be slopes greater than those of the wedge on the microlens. If in (5) we replace the value of the refractive index of silica (n_{SiO2}≡1.46), we find that α_{c}≡43.2°, from which when imported into (11), it is found that θ_{w.critical}≡93.6°. This means that in the expression (3), the function T(x,y) may be omitted provided that the relation (10) is satisfied.

The experiment was conducted taking a laser diode with emission wavelength 980 nm, manufactured by the Applicant, and with ω_{LOx}=3 μm and ω_{LOy}=0.68 μm, representing the MFR values in the two perpendicular directions for the laser.

Furthermore, with lenses having a radius of curvature between 3 μm and 8 μm, the distance between fibre and laser is advantageously between 5 μm and 10 μm.

Lenses were considered that were set on wedges at an angle of respectively 110° and 55° in order to evaluate the extent to which the finite aperture of the microlens affects the coupling efficiency and the sensitivity to misalignment, for in fact 55°<θ_{w.critical}<110°. On comparing the peak coupling efficiency (CE in FIGS. 5a, 5b and 6a, 6b) between the graphs 5a,b and 6a,b, it can be seen that, with the solution that envisages a θ_{w}=110°(>θ_{w.critical}), coupling efficiency peaks are obtained that are much greater than those with lenses placed on a wedge with an angle of 55°. This is because if θ_{w}<θ_{w.critical}, the surface of the wedge acts as a screen to the radiation incident upon it.

Furthermore, the Applicant has found that the maximum value of CE is obtained when a cylindrical microlens is made on a wedge having an angle θ_{w} only slightly greater than the critical angle (e.g. θ_{w}=95°; remembering in fact that for silica fibres, θ_{w.critical}≡93.6°).

Preferably said angle of the wedge must not exceed 3°; an optimal value is represented by an angle not in excess of 1.5°. In general, it is expedient for the wedge angle to be not more than 10° greater than the value of the critical angle.

In a situation of this kind, not only do the drawbacks related to the finite numerical aperture of the lens disappear, but another drawback is also eliminated, namely that relative to the fact that the greater the angle θ_{w}, the lower the capacity of the lens to focus a divergent beam.

Using the formula of the overlap integral, the coupling efficiency pattern was determined as a function both of the fibre's MFR and of the radius R of the microlens described in the previous paragraph.

The experiment was conducted taking a single-mode fibre having an MFR of 1.9 μm, a wedge of angle 55°, 95° and 110° and a laser diode, with emission wavelength 980 nm and output power P_{w}=140 mW, manufactured by the Applicant, and with ω_{LOx}=3 μm and ω_{LOy}=0.68 μm, representing the MFR values in the two perpendicular directions for the laser. Furthermore, when using lenses with a radius of curvature between 3 μm and 10 μm, the distance between fibre and laser is advantageously between 5 μm and 12 μm. In general, the distance between the fibre and the device depends on the point of focusing of the lens plus wedge system, which can be calculated using relations known to those acquainted with the sector art. The results of the experiment are shown in the graphs of FIGS. 7a, 7b and 7c.

The Applicant has observed that, using a wedge with an angle of 55°, a single-mode fibre with MFR of 1.9 μm and a lens with radius of 3.5 μm, (FIG. 7a) the coupling efficiency is approximately 74%.

The Applicant has observed that, using a wedge with an angle of 110°, a single-mode fibre with MFR of 1.9 μm and a lens with radius of 3.5 μm, (FIG. 7a) the coupling efficiency is approximately 76%.

The Applicant has observed that, using a wedge with an angle of 110°, a single-mode fibre with MFR of 1.9 μm and a lens with radius of 3.5 μm, (FIG. 7a) the coupling efficiency is approximately 80%.

It is noted that the maximum coupling efficiency, with all other conditions being equal, is obtained with a wedge angle only slightly greater than the critical angle.

Another experiment was conducted using a different type of laser with a maximum MFR greater than the laser used previously. Such a laser is described, for example, in the article published in the magazine “IEEE Journal on selected topics in quantum electronics”, Vol. 3, no. 2 of Apr. 2, 1997 and is called a “flared” laser. The laser described in the article is capable of emitting an optical beam with an MFR up to 5 μm, for example 4 μm. Greater MFR values are also possible. Such a laser is farther described in U.S. Pat. No. 5,703,897.

A flared laser 100 is depicted by way of example in FIG. 8, comprising a semiconductor substrate 101, a lens 102 and a diffraction grating 103.

Fabricated on said semiconductor substrate 101 are a single-mode waveguide 104 communicating at one end with a flared waveguide 105, from the face 106 of which emerges an optical beam which is inserted in the optical fibre 1.

Said lens 102 is dimensioned in such a way as to collimate, in the direction of the grating 103, the beam exiting from the face 107 of the single-mode waveguide 104. Preferably the face 107 and the grating 103 are coated with a layer of non-reflecting material, obtained using a known technique. The face 106 is coated with a semireflecting mirror, obtained using a known technique.

The flared waveguide 105, the mirror on the face 106 and the diffraction grating 103 form a resonant cavity with selective wavelength, in which the grating performs selection of the wavelength sent to the single-mode waveguide 104.

The flared waveguide 105 can assume various flaring configurations. One flaring is illustrated by way of example in FIG. 8, where the expansion is a linear function. Similarly a flaring may be formed, where the expansion is for example an exponential function, or another kind.

The beam exiting from said laser is highly elliptical and has a very low divergence in the direction along which the MFR is maximum (about 6 μm).

The Applicant has determined the coupling efficiency between the laser 100 and the fibre 1 for three wedge angles on the fibre termination, respectively for a fibre with MFR=2.8 μm and for a fibre of the same type with expanded core (TEC) with MFR on the termination of 5.8 cm, summarized in the table below:

| | | | |
|---|---|---|---|
| FLARED | θ = 55° | θ = 110° | θ = 95° |
| LASER | | | |
| λ = 980 nm | | | |
| P_{w} = 210 mW | | | |
| ω_{OX} = 6 μm | | | |
| ω_{OY = 0.68 μm} | | | |
| Fibre MFR = | 68% R = 4.5 μm | 74% R = 3 μm | 75% R = 3.5 μm |
| 2.8 μm | | | |
| Fibre MFR = | 84.5% LR = 9 μm | 92% LR = 7.5 μm | 96% LR = 7 μm |
| 5.8 μm | | | |

The Applicant has determined that the MFR value of the fibre with the modified core that maximizes the coupling efficiency is very similar to the maximum MFR of the optical device, for example in this case of the laser diode (see FIGS. 7a,b,c). The Applicant believes that various factors contribute to the coupling efficiency. More particularly, considering the direction perpendicular and parallel to the greater axis of the elliptical beam to be coupled:

in the perpendicular direction (y direction of FIG. 3), the decoupling between the elliptical beam (for instance, the laser beam) and the fundamental mode of the fibre is almost completely eliminated by the cylindrical lens, the radius of which increases as the MFR is increased in that direction;

in the parallel direction (x direction of FIG. 3), the fibre is plane whereas the beam, remaining very close to the source, may be assumed to be collimated and the lack of phase harmony is therefore negligible; in order to maximise amplitude harmony, attempts must be made to ensure that the fibre MFR dimension is substantially equal to the ω_{LOx} value which, in the case in hand, is 6 μm.

It will be clear from this description that, with a cylindrical lens, the MFR value that permits maximization of the coupling efficiency is approximately equal to ω_{LOx}. Therefore, for variations of the source value ω_{LOx} alone, with a cylindrical lens, the fibre end will expediently have an MFR equal to ωLOx.

This invention is applicable to all single-mode optical fibres, for example optical fibres with parabolic profile refractive index, step-index optical fibres, non zero dispersion (NZD) optical fibres and dispersion shifted (DS) fibres.

The Applicant has determined that the MFR value on the end of the fibre advantageously should not differ from the maximum MFR of the optical device by more than 20%.

Preferably the MFR value on the end of the fibre must not differ by more than 10% from the maximum MFR of the optical device.

The considerations set down above are valid for a cylindrical microlens, but more generally it may be said that the possibility of locally varying the MFR value on the end of the fibre upon which a microlens is set, may produce considerable advantages in terms of quality of the source/fibre coupling.

By way of conclusion, it should be said that the optimization of the lens placed on a wedge of angle θ_{w} comprises the steps of:

1. optimising the fibre MFR, typically MFR≡ω_{LOx} is selected;

2. optimising the wedge angle: advantageously, θ_{w} will be slightly greater than θ_{w.critical}, followed by the fabrication of an aspherical microlens on the edge of the wedge.

Although the best results are had from the combination of steps 1 and 2, each of the two steps separately still permits an improvement in the coupling efficiency with respect to the known art.

In the event of an optical fibre having an MFR greater than that of the device with which it is to be coupled, coupling efficiency is maximized by shrinking the fibre core rather than expanding it. One technique enabling a fibre core to be shrunk may, for example, comprise a heating and pulling of the fibre in order to reduce its outer diameter and accordingly the core diameter.

The microlens on the termination of the fibre as described may be made using a variety of fibre machining methods. For example, a known method for making a wedge on the end of the fibre comprises a lapping. By holding the fibre down on a lapping wheel (for a given period of time at a suitable pressure), a first wedge face is obtained. If the fibre is then rotated by 180° about its own axis and the operation is repeated, the wedge-shaped microlens is obtained. Thereafter, by means of an arc discharge or electrolysis, rounding of the wedge edge can be produced and thus a cylindrical microlens obtained.

The lapping operation may be controlled, according to a known technique, for example as described in U.S. Pat. No. 5,455,879, by the depositing of a layer of aluminium of such dimensions that the end behaves as a mirror. Thus, if a laser beam is emitted from the end opposite the end which is metallized, this beam will be completely reflected. Accordingly it will be possible to control how much of the energy emitted by the source is reflected by the aluminium surface. This energy value will vary as soon as lapping starts on the layer of aluminium coating the tip of the fibre in the vicinity of the core (it should be remembered, in fact, that the beam present in the fibre is almost completely confined to the core).

Thus the fibre machining operations are controlled in real time, and at the same time the microlens and the core are guaranteed to be perfectly concentric.

A coupling system according to this invention may be advantageously used for optically connecting a pump laser of an amplifier to an optical fibre that carries the pumping light in an active fibre through, for instance, an optical coupler; the amplifier could advantageously be inserted in a multiwavelength telecommunications system comprising two terminal stations, one for transmitting and one for receiving.

In particular, the transmitting station comprises N>1 optical signal transmitters, each with a wavelength.

The number N of independent wavelengths adopted for the signals of each transmitting station, corresponding to the number of optical channels that can be used for transmitting, can be selected in relation to the characteristics of the telecommunications system.

The optical transmitters comprised in the transmitting stations are directly modulated or externally modulated transmitters, depending on the system requirements; more specifically, these requirements may be related to the chromatic dispersion of the optical fibres of the system, to their length and to the transmission speed envisaged.

The outputs of each of the transmitters of the transmitting stations are connected respectively to multiplexers which direct the relative optical signals towards a single output which is connected to the input of optical power amplifiers.

In general, the multiplexers are passive optical devices, through which the optical signals transmitted on respective optical fibres are superposed into a single fibre; devices of this type consist, for example, of fused fibre couplers, in planar optics, microoptics and similar.

By way of example, a suitable multiplexer is that marketed under the name SMTC2D00PH210 by E-TEK DYNAMICS INC. of 1885 Lundy Ave, San Jose, Calif. (USA).

The power amplifiers elevate the level of the signals generated by the transmitting stations to a value sufficient to travel through the next section of optical fibre before the receiving station or amplifying means, maintaining a sufficient level of power at the end to ensure the required transmission quality.

For the purposes of this invention and for the use described above, a commercial type fibre optical amplifier is, for example, suitable for the power amplifiers, having an input power of between −13.5 to −3.5 dBm, and output power of at least 13 dBm.

A suitable model, for example, is the TPA/E-MW marketed by the Applicant and using active optical fibre doped with Erbium.

Accordingly, respectively connected to the power amplifiers are a length of optical line, usually consisting of a single-mode, step-index or NZD or DS type optical fibre, inserted in a suitable optical cable, several tens (or hundreds) of kilometers long, for example, with the amplifying means described below and the power levels indicated, approximately 100 kilometers.

At the end of these lengths of optical line there are one or more intermediate stations for amplifying the optical signal, each comprising line amplifiers suitable for receiving the signals, which have been attenuated while travelling along the fibre path, and for amplifying them to a level sufficient to feed them respectively to several successive stretches of optical line, covering the total transmission distance required until reaching a preamplifier or another amplifying station respectively. By preamplifier is meant, in the context of this invention, an amplifier dimensioned to compensate for the losses in the last stretch of optical line and the losses from insertion of the successive demultiplexer stages, so that the signal input to the receiving stations has a suitable power level for the sensitivity of the device. The preamplifier has the further task of limiting the dynamics of the signals, by reducing the variation of the power level of the signals input to the receiver with respect to the variation of the power level of the signals coming from the transmission line. One type of preamplifier suitable for this use of the preamplifiers is, for example, a commercial type optical amplifier made from active optical fibre doped with Erbium, having a total input power of between −20 and −9 dBm and output power of 0-6 dBm.

A suitable model is, for example, the RPA/E-MW marketed by the Applicant.

The optical signals multiplexed at the output of the preamplifiers respectively reach the demultiplexers, which are suitable for separating the signals into N optical fibres at their output, depending on the respective wavelengths, which will be sent to the respective N receivers comprised in the receiving station. A demultiplexer suitable for use in the present transmitting system is, for example, the demultiplexer described in the patent application EP854601, filed on behalf of the Applicant.

In the event that the optical signals to be transmitted are generated by sources of signals possessing intrinsic transmission characteristics (such as wavelength, modulation type, power) that are different from those envisaged for the connection described, each transmitting station comprises interfacing units suitable for receiving the optical signals generated by the transmitting stations, for extracting them, for regenerating them with new characteristics suited to the transmission system and for sending them to the multiplexers.

In U.S. Pat. No. 5,267,073, filed by the Applicant, interfacing units are described comprising in particular a transmission adapter, suitable for converting an input optical signal into a form suitable for the optical transmission line, and a reception adapter, suitable for reconverting the signal transmitted into a form suitable for a receiving unit.

For use in such a system, the transmission adapter preferably comprises, as its output signal generating source, an externally modulated laser.

This optical fibre telecommunications system, in addition to the channels intended for the communication signals and put at the disposal of users, also has an independent channel, suitable for permitting service signals to be transmitted. A system comprising channels intended for service signals is described in U.S. Pat. No. 5,113,459, filed by the Applicant.

These service signals may be of different kinds, for example alarm notification signals, signals for controlling or commanding equipment, such as repeaters or amplifiers, placed along the line, or for communications between maintenance personnel, operating at a point along the line, and an intermediate station or a station at the end of the line.

In such cases, further signals need to be introduced into the communication line, that can be received and input at any intermediate station or at the terminal stations. These service signals are transmitted at a wavelength considerably different from the communication wavelength, i.e. one that can be separated by means of an appropriate dichroic coupler.

Although the service signals are advantageously input to and extracted from the optical line at the line end stations and at the line amplifiers, as previously described, dichroic couplers and relative stations for receiving and transmitting service signals may also be placed at any other point on the optical fibre line, wherever the need arizes.

The optical amplifiers generally comprise at least one active fibre doped with a rare earth, suitable for generating an amplification of the multiwavelength transmission signal in response to the supply of light radiation at a pumping wavelength.

This pumping wavelength is different from that of the transmission signals and is produced by at least one pumping source of said active fibre, having an optical power that can be controlled by a station control unit, inside which the amplifier itself is found; by way of example, this source could be a laser. In addition, the amplifier comprises a dichroic coupler for sending said pumping radiation and said transmission signal into the active fibre.

This dichroic coupler is, for example, produced by way of melting and drawing of two single-mode optical fibres, both at the pump wavelength and at the signal wavelength.

A pumping device according to this invention could advantageously be connected to an input of the dichroic coupler.

1. Laser emission system comprising
a laser (100) suitable for transmitting an elliptical optical beam at an emission wavelength less than 1000 nm, having a first maximum MFR, comprising a flared optical waveguide (105),
a single-mode optical fibre (1) at said emission wavelength, having a terminal portion with a second MFR,
characterized in that said MFR of said fibre does not differ from said first maximum MFR of the laser (100) by more than 20%.

2. Laser emission system according to claim 1, characterized in that an aspherical lens (6) is formed on said terminal portion of said optical fibre (1).

3. Emission system according to claim 2, characterized in that said aspherical lens comprises a pair of inclined surfaces (41, 42) which intersect on a line, generating an edge, in a position substantially corresponding to the centre of the core (2) of said fibre (1), said edge being rounded to form an aspherical profile.

4. Emission system according to claim 1, characterized in that said fibre (1) is of the TEC (Thermal Expanded Core) type.

5. Emission system according to claim 4, characterized in that said inclined surfaces (41, 42) together form an angle that is greater than the critical angle (θ_{w.critical}).

6. Emission system according to claim 4, characterized in that said inclined surfaces (41, 42) together form an angle that is greater than the critical angle (θ_{w.critical}) by not more than 10°.

7. Coupling system between an optical waveguide (1) and an optical device (8) suitable for receiving and/or transmitting an optical beam having a first maximum MFR, comprising a single-mode optical fibre (1) having at one end a portion (10) of its core (2) expanded by at least 10% so as to determine a second MFR,
characterized in that
an aspherical lens (6) is formed on said end of the fibre (1).

8. Coupling system according to claim 7, characterized in that said aspherical lens comprises a pair of inclined surfaces (41, 42) which intersect on a line, generating an edge, in a position substantially corresponding to the centre of said core (2), said edge being rounded to form an aspherical profile.

9. Coupling system according to claim 7, characterized in that the value of said MFR of said fibre along the direction of the greater axis of the elliptical beam does not differ from the MFR value of the optical device (8) by more than 20%.

10. Coupling system according to claim 8, characterized in that the inclined surfaces (41, 42) together form an angle that is greater than the critical angle (θ_{w.critical}).

11. Coupling system between an optical fibre (1) and an optical device (8) suitable for transmitting and/or receiving an optical beam
characterized in that
one termination of said optical fibre (1) comprises an aspherical lens (6) disposed on the edge of a wedge (4) formed by a pair of inclined surfaces (41, 42), said surfaces together forming an angle (θ_{w}) that is greater than the critical angle (θ_{w.critical}) by not more than 10°.

12. Method for coupling a single-mode optical fibre with an optical device receiving or transmitting an elliptical optical beam characterized in that it comprises the following steps:
expanding the geometrical dimensions of the core of said fibre so as to obtain an MFR that does not differ from the MFR value of the optical device (8) by more than 20% along the direction defined by the greater axis of the elliptical beam,
making a wedge on the termination of the fibre, the edge of which corresponds to this greater axis, said wedge having an angle (θ_{w}) greater than the critical angle (θ_{w.critical}),
making an aspherical lens on the edge of this wedge.

13. Method according to claim 12, characterized in that, in said step of making a wedge on the termination of the fibre, said wedge has an angle (θ_{w}) that is greater than the critical angle (θ_{w.critical}) by not more than 10°.

14. Optical fibre (1) suitable for coupling with an optical device (8), comprising a single-mode optical fibre (1) having a core with a first MFR and a portion (10) of its core (2) expanded with a second MFR greater than said first MFR by at least 10%,
characterized in that
an aspherical lens (6) is formed on said end of the fibre (1).

15. Optical fibre according to claim 14, characterized in that said aspherical lens comprises a pair of inclined surfaces (41, 42) which intersect on a line, generating an edge, in a position substantially corresponding to the centre of said core (2), said edge being rounded to form an aspherical profile.

16. Optical fibre according to claim 14, characterized in that said fibre is of the TEC (Thermal Expanded Core) type.

17. Optical fibre according to claim 15, characterized in that said inclined surfaces (41, 42) together form an angle that is greater than the critical angle (θ_{w.critical}).

18. Optical fibre according to claim 15, characterized in that said inclined surfaces (41, 42) together form an angle that is greater than the critical angle (θ_{w.critical}) by not more than 10°.
